(19) United States
(12) Patent Application Publication
(10) Pub. No.: US 2026/0181468 A1
(43) Pub. Date: Jun. 25, 2026

(54) METHODS AND SYSTEMS FOR HANDLING AND REPORTING OF COLLECTED DATA WITH DIFFERENT PRIORITIES

(71) Applicant: InterDigital Patent Holdings, Inc., Wilmington, DE (US)

(72) Inventors: Dylan Watts, Montreal (CA); Oumer Teyeb, Montreal (CA); Patrick Tooher, Montreal (CA); Yugeswar Deenoo Narayanan Thangaraj, Chalfont, PA (US); Brian Martin, Farnham (GB); Virgil Comsa, Montreal (CA)

(73) Assignee: InterDigital Patent Holdings, Inc., Wilmington, DE (US)

(21) Appl. No.: 18/990,467

(22) Filed: Dec. 20, 2024

(51) Int. Cl. H04W 28/02; H04W 24/10

(52) U.S. Cl. CPC H04W 28/0278; H04W 24/10

(57) ABSTRACT

A wireless transmit/receive unit (WTRU) may comprise a processor. The processor may be configured to handle data collection procedures, wherein the data has more than one priority associated with it. For example, the WTRU may be configured to collect data for a first data collection and a second data collection, wherein the first data collection is associated with a first priority and the second data collection is associated with a second priority. The WTRU may make and store measurements for each data collection. The WTRU may store the measurements in a buffer and may mark the data with the appropriate priority. The WTRU may detect when the buffer is full and perform buffer management, for example, by deleting data of lower priority, and/or reporting data.

### BACKGROUND

A cellular system may support data collection for artificial intelligence and/or machine learning (AI/ML). The integration of AIML into 5G NR may enhance air-interface performance (e.g., provide improved throughput, robustness, accuracy, or reliability, etc.) and/or reduce complexity/overhead. Selected features based on an assessment of their performance in comparison with traditional methods and the associated potential specification impact include AIML for beam management, positioning, and CSI prediction.

Part of the general framework that may support the above use cases includes the definition and standardization of both WTRU-side and NW-side data collection. Data collection may be performed for different purposes in lifecycle management (LCM). For example, data collection may be performed for model training, model inference, model monitoring, model selection, model updates, etc. Each use case may have different requirements and potential specification impact. At least for the use cases studied (e.g., beam management, positioning, and CSI prediction), the analysis/selection of the data collection frameworks has focused on the RRC_CONNECTED state for both data generation and reporting.

### SUMMARY

Devices in cellular systems may have capabilities associated with AIML. Devices may support configuration, capability reporting, and indication of support for various aspects of the handling and reporting of collected data with different priorities. Devices may receive configurations to support the collection, management, and reporting of data with different priorities.

Devices may support managing collected data with different priorities. Embodiments for supporting the collection and/or management of data with different priorities may include: methods and initiation of data collection prioritization; and identification, methods, and triggers to remove lower priority data (e.g., to support continued collection of high-priority data in the data collection buffer).

Devices may support reporting collected data with different priorities. Embodiments for supporting the definition and reporting of a data collection buffer status report (BSR) and/or of the collected data with different priorities may include: the definition, contents, and triggering transmission of a new data collection buffer status report (BSR); and the trigger criteria and transmission of collected data with different priorities.

A wireless transmit/receive unit may receive one or more messages comprising configuration information for a first data collection and/or a second data collection. Each data collection may be associated with a priority. For example, the first data collection may be of higher priority than the second data collection. The WTRU may perform data collection in accordance with the configuration information for each data collection. For example, the WTRU may make measurements (e.g., reference signal received power (RSRP), signal to interference plus noise ratio (SINR), reference signal received quality (RSRQ), etc.) and may store the measurements in a buffer. Upon determining that the buffer is full, the WTRU may perform buffer management. For example, the WTRU may delete data associated with a lower priority data collection (e.g., to make space for higher priority data) and may continue collecting data (e.g., higher priority data). The WTRU may report results of the data collections to the network (e.g., in a buffer status report for data collection).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a flow chart showing an example of a process for collecting and/or managing data with different priorities.

### DETAILED DESCRIPTION

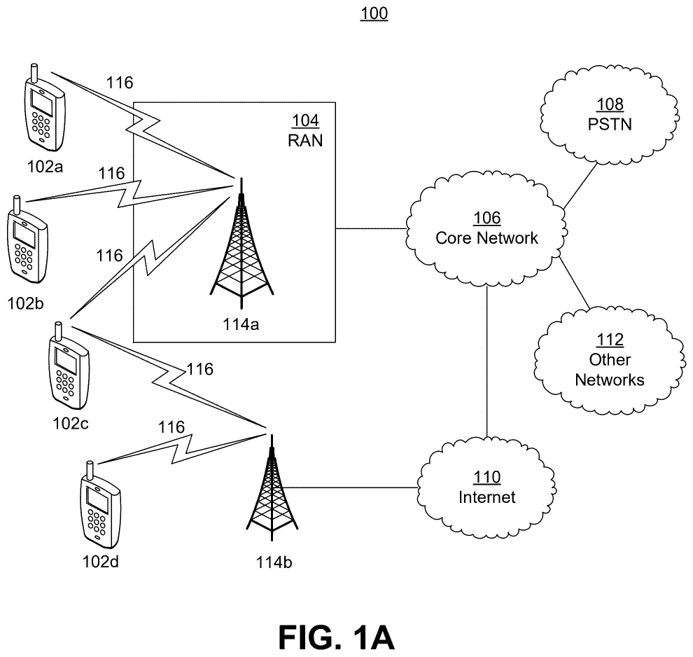

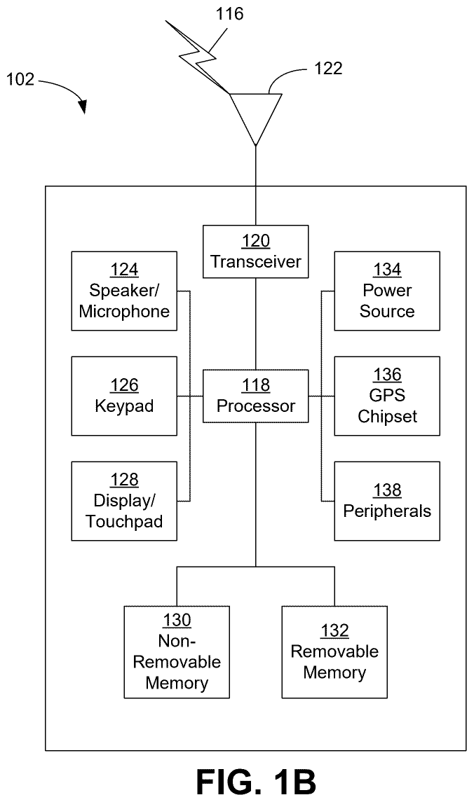

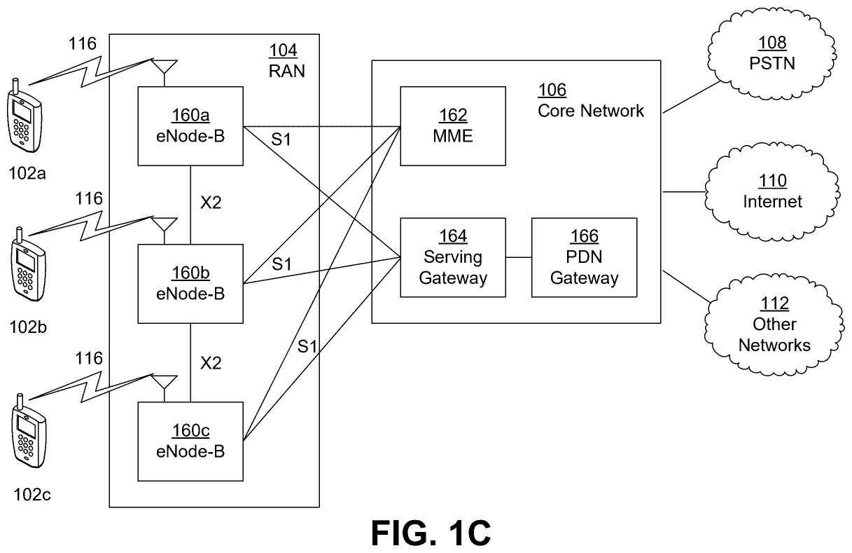

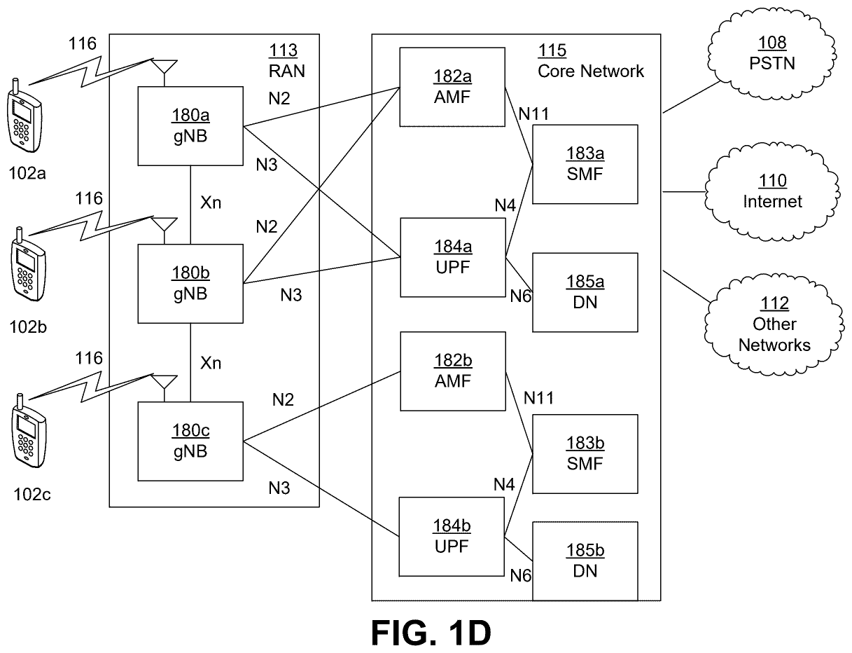

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114 a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily, or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11 ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

For network-side data collection, both periodic and event triggered (e.g., based on layer 3 (L3) and/or layer 1 (L1) measurements and beam-based events) data logging is supported. To report the logged data, the WTRU may rely on a network request via a WTRU information request/response procedure. Logged data includes at least layer 1 (L1)-reference signal received power (RSRP) values and/or beam IDs.

For WTRU-side data collection, the data collection initiation, termination, and configuration for data collection (e.g., measurement resource configuration and Associated ID) may be under network control. The WTRU may request a data collection configuration (e.g., if enabled by the network). However, the network may provide a data collection configuration at any time.

The embodiments described herein enable differentiated handling of collected data during AIML data collection. As the number of use cases in cellular systems for data collection and the amount of data collected increases, the current logged minimum drive test (MDT) framework used for collecting/reporting data for data collection purposes may not be sufficient to differentiate between the types of data being collected and/or the purposes of the data. Certain types of data may be more important than others, but may not get logged due to excessive collection of lower-priority data (e.g., causing filled buffer).

Current techniques used in cellular systems (e.g., 5G) may not be ideal for data collection involving different types of data and/or purposes for the data. For example, some data collection procedures use the existing MDT framework for logging and reporting. The following issues may arise when considering a more flexible data collection framework. First, MDT does not allow differentiation of logged data/QoS handling among collected data is limited. Second, triggers for logging and reporting MDT are limited, and do not distinguish between data collection types. Third, MDT can only be transmitted in a CONNECTED state, which is partially due to security concerns (e.g., position) which may not be an issue for some data collection.

The embodiments described herein may support differentiated handling of collected data during AIML data collection. A WTRU may receive configuration information including a first data collection configuration associated with a first priority, a second data collection configuration associated with a second priority, and/or criteria to trigger a data collection BSR/report collected data. WTRU may perform data collection according to the first and second measurement configurations. Performing the data collection may involve making measurements (e.g., RSRP, signal to interference plus noise (SINR), reference signal received quality (RSRQ)), marking the measurements (e.g., with a priority), and/or storing the measurements in a data logging buffer. Upon detecting that the data logging buffer is full, the WTRU may trigger a data collection buffer status report (BSR) indicating the amount of first and/or second priority data in the buffer. Based on network response and/or configuration, the WTRU may report the collected data. Based on network response and/or configuration, the WTRU may perform buffer management procedures. For example, the WTRU may delete some or all of the collected data associated with the second priority and continue to perform data collection (e.g., only for the first data collection).

The WTRU may take actions and/or steps to support data collection with data of different priorities. The WTRU may receive a message (e.g., via RRC Release message) from a first cell comprising configuration information that includes one or more of the following criteria or configurations. The configuration information may include a first data collection configuration associated with a first priority and a second data collection configuration associated with a second priority (e.g., associated with different use cases for data collection). The configuration information may include criteria to trigger a data collection BSR. The criteria may be based on the ratio of first priority data and second priority data within the buffer (e.g., 30%/70%, 60%/40% etc.). The configuration information may include criteria to trigger an RRC Setup/Resume to report collected data (e.g., based on a ratio of first and second priority data (e.g., 90-10%).

The WTRU may perform data collection according to the first and/or second measurement configurations. The WTRU may store data collected according to the first and/or second measurement configurations in one or more data logging buffer(s). The WTRU may detect that a data logging buffer becomes full or is full up to a configured threshold (e.g., 80% full).

If the WTRU detects the ratio of first and second priority data has met the configured threshold to initiate RRC Setup/Resume procedure, then the WTRU may transmit a message indicating that the buffer is full (e.g., or X% full). The message may be an RRC Setup/Resume message with resume cause “data collection buffer filled.” The message could alternatively, or additionally be included in dedicated RACH resources, preambles etc. The WTRU may receive resources for data collection reporting (e.g., within the RRC Setup/Resume Complete message). If the resources provided for data collection are insufficient for the amount of buffered data, the WTRU may prioritize transmission of first-priority data (e.g., if configured to do so).

If the WTRU detects that the ratio of first-priority data and second-priority data has met criteria to trigger a data collection BSR, the WTRU may transmit a data collection buffer status report. The WTRU may receive an indication from the network to 1) report the collected data; and/or 2) deletes collected data associated with the second priority (e.g., to make space for first priority data) and continue to perform data collection.

If there is data associated with a second priority in the WTRU buffer, reporting criteria are not met (or configured), and the WTRU is configured to delete second priority data, then the WTRU may delete collected data associated with the second priority (e.g., to make space for first priority data) and continue to perform data collection.

If none of the conditions discussed herein are met, then the WTRU may stop data collection upon detecting the data logging buffer has become full.

Differentiation of logged data for data collection can ensure efficient WTRU-side buffer management, logging, and timely reporting when considering a variety of possible use cases for data collection in future AIML operation. Embodiments described herein support differentiated handling of collected data during AIML data collection.

The terms ‘AI/ML operation’ or ‘AIML operation’ may be used herein in reference to operations relating to artificial intelligence and/or machine learning models. For example, model training, inference, performance monitoring, data collection, are all examples of AIML operations.

A WTRU may be configured and have the capability to support handling and reporting of collected data with different priorities.

A WTRU may be provided with one or more configuration(s) (e.g., configuration information) for differentiated handling and reporting of collected data. Examples may include configurations to support one or more of: AI/ML operation; managing collected data with different priorities; and/or reporting collected data with different priorities.

Differentiated handling and reporting of collected data may (e.g., additionally) be initiated if (e.g., only if) supported by both the WTRU and network (NW). A WTRU may indicate its capability for one or more aspects of differentiated handling and reporting of collected data (e.g., prior to initiation of the procedure or reception of associated configurations). A NW may indicate support (e.g., per cell) for one or more aspects of differentiated handling and reporting of collected data. A WTRU may, for example, initiate a procedure and/or expect configuration with (e.g., only with) cell(s) which support the procedure.

Embodiments described herein support indications of WTRU capability, NW support, and the reception (e.g., by the WTRU) of one or more configurations to support differentiated handling and reporting of collected data.

Capability and network support for differentiated handling and reporting of collected data is described herein. In some embodiments, a capability may be required for differentiated handling and reporting of collected data. The capability may be related to all aspects differentiated handling and reporting of collected data or one or more aspects. Support for differentiated handling and reporting of collected data may be reported by the WTRU and/or indicated by the network (e.g., on a cell-specific basis).

A WTRU may be configured for capability reporting for differentiated handling and reporting of collected data. The WTRU may indicate its capability and/or support for one or more aspects of differentiated handling and reporting of collected data. In examples, the WTRU may indicate a single capability to indicate support for all aspects of differentiated handling and reporting of collected data. In examples, the WTRU may report support for one or more (e.g., each) aspect of differentiated handling and reporting of collected data. For example, the WTRU may indicate support for one or more of the following capabilities.

The WTRU may indicate support for the collection of data with different priorities. The WTRU may indicate support for updating the priorities of collected data. The WTRU may indicate support for semi-static prioritization of data collection. The WTRU may indicate support for dynamic prioritization of data collection. The WTRU may indicate support for conditional application of data collection prioritization. The WTRU may indicate support for removal of collected data within a buffer. The WTRU may indicate support for transmission of a data collection BSR. The WTRU may indicate support for reporting of multi-priority collected data.

The WTRU may report the capability of one or more of the above aspects of differentiated handling and reporting of collected data, for example, via the WTRU capability transfer procedure. In another example the WTRU may indicate capability and/or support via one or more of the following methods.

The WTRU may indicate capability and/or support during random access procedures. The WTRU may indicate capability and/or support using one or more dedicated resources, and/or random access preamble partitioning (e.g., a set of reserved preambles or random access occasions, RNTIs etc.). The WTRU may indicate capability and/or support upon RRC connection establishment and/or resumption (e.g., in Msg3 or Msg5). The WTRU may indicate capability and/or support upon request from the network (e.g., upon reception of the capability enquiry message). The WTRU may indicate capability and/or support via a UE/WTRU assistance information.

A WTRU's, capability to support/perform/execute/initiate one or more aspects of differentiated handling and reporting of collected data may be reliant/linked to one or more other configurations. For example, the network may assume that a WTRU is capable of one or more aspects of differentiated handling and reporting of collected data based on, for example, the activation, state, and/or configuration one or more of the following configurations or functionalities.

The NW may assume that a WTRU is capable of one or more aspects of differentiated handling and reporting of collected data based on the WTRU's configuration of an AIML model and/or functionality. The NW may assume that a WTRU is capable of one or more aspects of differentiated handling and reporting of collected data based on the activation of an AIML model and/or functionality at the WTRU. The NW may assume that a WTRU is capable of one or more aspects of differentiated handling and reporting of collected data based on the availability of an AIML model and/or functionality at the WTRU.

The capability and/or support for initiation of one or more aspects of differentiated handling and reporting of collected data may be reliant on one or more characteristics of the WTRU. For example, the WTRU's capability and/or support for initiation of one or more aspects of differentiated handling and reporting of collected data may be reliant on: the performance of an AIML model and/or functionality; WTRU speed; remaining WTRU power; WTRU processing ability; WTRU location (e.g. within a certain set of cells, using one of a set of specific beams, GPS location, etc.); and/or a particular type of service being used (e.g. related to one or more specific network slices or QCIs).

If a WTRU is configured for differentiated handling and reporting of collected data and an associated configuration is not present/active and/or the WTRU characteristics are not suitable, it may be assumed that the procedure is temporarily disabled (e.g., the WTRU may not initiate the procedure) or inactive. The WTRU may indicate (e.g., subject to configuration) to the network that differentiated handling and reporting of collected data is temporarily inactive (e.g., via a MAC CE, UCI and/or RRC signaling). In some embodiments, the WTRU may also report the reason for why the procedure is inactive (e.g., a joint configuration is disabled, or the WTRU characteristics are not suitable).

A NW may support differentiated handling and reporting of collected data. In some embodiments, the network may indicate support for differentiated handling and reporting of collected data. Support for differentiated handling and reporting of collected data may be, for example, per cell, per PLMN, per frequency or frequency range, per tracking area (TA) or RAN notification area (RNA). In examples, the indication may be, for example a flag and/or bit in system information which indicates support for differentiated handling and reporting of collected data. In examples, the NW may indicate support for an aspect of the procedure (e.g., that the cell supports differentiate handling of collected data, but not transmission of a data collection BSR etc.). In examples, the network may indicate (e.g., within system information and/or via RRC configuration) a list of one or more cell(s) which support differentiated handling and reporting of collected data.

The WTRU may initiate differentiated handling and reporting of collected data or one or more aspects of differentiated handling and reporting of collected data subject to the network supporting the procedure (e.g., only if the network supports the procedure). For example, the WTRU may resume differentiated handling and reporting of collected data if (e.g., only if) the cell has indicated support for differentiated handling and reporting of collected data.

Configuration(s) to support data collection are discussed herein. In some embodiments the WTRU may receive configuration(s) to support one or more AIML operation(s) including data collection. Configuration(s) for data collection may include, for example, one or more of: measurement configuration(s); associated ID(s); NW-side additional conditions; limits on the amount of data collected; types of data and/or events to collect; triggers to report collected data; and/or formats to report collected data.

Configuration(s) for managing collected data with different priorities are discussed herein. In some embodiments the WTRU may receive configuration(s) for managing collected data with different priorities. Examples include configurations for the collection and management of data with different priorities.

Configuration(s) for collection of data with different priorities are discussed herein. In some embodiments, a WTRU may receive configuration(s) for collecting of data with different priorities. Such configuration(s) may include, for example, indications of one or more of the following pieces of information.

Configurations for collecting data with different priorities may include an indication of whether the WTRU can prioritize collected data. Configurations for collecting data with different priorities may include an indication of whether the data collection prioritization is semi-static. Configurations for collecting data with different priorities may include an indication of whether the network will dynamically update the priority of the data collection. Configurations for collecting data with different priorities may include an indication of whether the WTRU may collect data associated with a measurement or event. Configurations for collecting data with different priorities may include an indication of triggers and criteria to support the initiation of data collection prioritization. Configurations for collecting data with different priorities may include an indication of how handling of stored data upon change of data collection priority should be performed (e.g., whether the WTRU should flush buffer, report data, update priority of data within the buffer, leave data as is within buffer).

Configuration(s) for managing data with different priorities are discussed herein. In some embodiments, a WTRU may receive configuration(s) for managing data with different priorities Such configuration(s) may include, for example, indications of whether the WTRU may delete data within the buffer; and/or whether the WTRU may autonomously deleted data within the buffer.

Configuration(s) for reporting collected data with different priorities are discussed herein. In some embodiments the WTRU may receive configuration(s) for reporting collected data with different priorities. Examples include configurations to support transmission of a data collection buffer status report, information about the collected data, and/or the collected data itself.

A WTRU may be configured to transmit a data collection buffer status report (BSR). The WTRU may receive configuration(s) to support transmission of a data collection buffer status report (BSR). Such configuration(s) may include, for example, an indication of whether the WTRU should send a basic or detailed data collection BSR; and/or an indication of condition(s) (e.g., associated thresholds, periodicity etc.) to trigger transmission of a data collection BSR.

A WTRU may be configured to report collected data with different priorities. The WTRU may receive configuration(s) for reporting collected data with different priorities. Such configuration(s) may include, for example and without limitation, one or more of the following indications: An indication of whether the WTRU can autonomously trigger reporting for collected data; an indication of whether the WTRU can transmit collected data with multiple priorities; an indication of conditions (e.g., thresholds, criteria) to report collected data; and/or an indication of whether the WTRU may report data in RRC Connected or in another RRC state.

A WTRU may be configured to adapt and/or manage its configurations relating to handling and/or reporting data collection with data of multiple priorities. The WTRU may use methods, as described herein, to (re)acquire, adapt, and/or release configurations associated with differentiated handling and reporting of collected data. This can help the WTRU to maintain related AIML configuration(s) and/or AIML operation.

A WTRU may perform signaling of differentiated handling and reporting of collected data configuration(s). The WTRU may be provided with configurations for differentiated handling and reporting of collected data. In examples, the configurations may be provided upon establishment/resumption of an RRC connection (e.g., within the RRC Setup/Resume message), upon handover to another cell (e.g., within a HO command/RRC reconfiguration message with a reconfiguration with sync), or at any time during an active RRC connection (e.g., via RRC reconfiguration message without reconfiguration with sync). In examples, configurations for differentiated handling and reporting of collected data may be indicated/configured/provided via one or more of the following signaling methods: SIB (e.g., a new SI block, or within another existing SIB), NAS, MAC CE, DCI, RACH (e.g., MSG2, MSG4, MSGB), RRC, and/or PDCCH/PUSCH.

The WTRU may receive different information and/or components of a configuration for differentiated handling and reporting of collected data via different signaling methods. For example, the WTRU may receive some dedicated configuration aspects via RRC signaling (e.g., which configuration(s) to maintain, dedicated RNTIs), and some other configurations or information via system information (e.g., the resources to monitor for a network indication to manage configuration(s) while outside of RRC connected state). If a WTRU is provided with a dedicated configuration/indication related to differentiated handling and reporting of collected data, the WTRU may override other common configuration information (e.g., received via broadcast signaling) or may combine the dedicated configuration with one or more pieces of common configuration information. In examples, the WTRU may use the most recently received information in the configuration regardless of the signaling method.

The WTRU may receive one or more alternative configurations using one signaling method (e.g., via system information or dedicated RRC signaling). Using another type of signaling (e.g., via dedicated RRC signaling or MAC CE) the network may select or indicate which of the one or more alternative configurations to apply.

A WTRU may support handling of configuration(s) for differentiated handling and reporting of collected data. The WTRU may receive a configuration based on a NW decision (e.g., upon release to RRC IDLE or RRC INACTIVE). In examples, the WTRU may receive a configuration based on a NW decision if the WTRU indicates it is capable of differentiated handling and/or reporting of collected data. In examples, the WTRU may request to be configured for differentiated handling and reporting of collected data.

The WTRU may request configuration(s) for differentiated handling and reporting of collected data, update existing configuration(s) for differentiated handling and reporting of collected data, and/or apply different configuration(s) for differentiated handling and reporting of collected data.

The WTRU may release related configurations for differentiated handling and reporting of collected data (e.g., all or one or more parts of a configuration). In examples, the WTRU may release related configurations for differentiated handling and reporting of collected data the current serving cell does not support differentiated handling and reporting of collected data. In examples, the WTRU may release related configurations for differentiated handling and reporting of collected data if the WTRU does not have an active, available, configured, or supported AIML functionality/model to perform data collection.

A WTRU may support conditional configuration adaptation. In examples, the WTRU may adapt (e.g., change) one or more aspects of configuration(s) for differentiated handling and reporting of collected data based on the WTRU characteristics. Examples of WTRU characteristics include but are not limited to: WTRU speed and/or position; WTRU power and/or battery level; and/or WTRU processing capability and/or load.

Upon detection of change in WTRU characteristics, the WTRU may modify one or more aspects of the current configuration and/or apply a new configuration. How the WTRU detects which aspects of the configuration to change may be based on conditions associated with the configuration and/or aspect(s) of the configuration. For example, the WTRU may be provided with one or more threshold(s), wherein if a threshold is exceeded (e.g., or if a value has fallen below a threshold) the WTRU will apply an alternative configuration and/or value for the same configuration.

A WTRU may manage collected data with different priorities. A WTRU may assign different priorities to data during data collection and logging. This may require differentiated handling and reporting of such data. Differentiation of logged data for data collection can enable efficient WTRU-side buffer management, logging, and/or timely reporting. This may be useful in a variety of possible use cases for data collection in AIML operation.

Embodiments described herein support the collection and management of data with different priorities. Embodiments described herein may include methods and initiation of data collection prioritization and/or methods and triggers to identify and remove lower priority data from a data collection buffer.

A WTRU may collect data with different priorities. In some embodiments the WTRU may collect data, wherein some of the data is of a different priority than some of the other data. The prioritization of the data may be based on pre-configuration and/or semi-static assignment. The prioritization of data may change over time (e.g., based on the needs of the WTRU and/or network). The prioritization of data may be contingent on conditions or characteristics, for example, the buffer status and/or characteristics of the WTRU.

A WTRU may be configured to assign priorities to collected data. In some embodiments, collected data may be assigned a priority (e.g., to support the logging, management, and/or reporting of collected data). In examples, the priority of the data may be semi-statically indicated and/or configured (e.g., within the measurement configuration). In examples, upon configuration (e.g., the data collection configuration), the specific data to be collected may be configured with a priority (e.g., the data collection configuration may indicate a priority of the data). In examples, the WTRU may be configured with several (e.g., more than one) data collection configuration(s). The WTRU may then receive (e.g., upon initiation of prioritization or after configuration) an indication of the priority of each data collection configuration.

The priority of the data may be dynamically modified. In examples, the network may indicate and/or modify the priority of a data collection configuration and/or the data within a data collection configuration (e.g., upon the occurrence of specific events and/or based on measurements). For example, the WTRU may receive a data collection configuration via RRC signaling. The network may then activate (e.g., or be triggered upon conditions being satisfied, as discussed herein) data collection prioritization. The WTRU may then receive (e.g., via DCI, MAC CE, or system information) a message including, for example, one or more of the following pieces of information. The message may include an indication (e.g., flag or bit) that data collection prioritization is activated. The message may include an identification of one or more data collection/measurement configuration(s) to be prioritized. The message may include an identification or one or more data, measurements, and/or event(s) within a data collection configuration to be prioritized. The message may include an indication of whether the prioritization is “high priority” or “low priority.” The message may include an indication of the relative priority of the data.

In examples, the network may assign a priority to a specific data collection configuration and/or set of data. The WTRU may request a specific set of data be assigned a priority. For example, the WTRU may require a specific measurement and/or type of data to train a model. In such a case, the WTRU may request the configuration and/or prioritization of a particular type of data from the network. In the request for prioritization, the WTRU may include, for example, one or more of the pieces of information described for the dynamic network activation of data collection prioritization to indicate which data is to be prioritized. The request may be transmitted via, for example, UCI, MAC CE, PUSCH, and/or RRC signaling. In examples (e.g., upon reception of the data prioritization request) the network may accept the request. If the acceptance simply ACKs the request, the WTRU may prioritize the data according to what was indicated within the request.

Additionally, or alternatively, the network may respond with a different set of priorities. If the network responds with a different set of priorities, the WTRU may subsequently prioritize the data collection configuration according to the network assignment.

In examples, the network may reject the request for data collection prioritization. Upon reception of a rejection from the network regarding data collection prioritization, the WTRU may perform one or more actions like those described for the discontinuation of data collection prioritization as described herein.

The network may discontinue prioritization of one or more data collections and/or data configuration(s). In examples, the network may indicate that all data collection prioritization is terminated. In examples, the network may indicate that a specific type of data and/or data collection prioritization configuration is discontinued. An indication for deactivating and/or discontinuing data collection prioritization may include, without limitation, any one or more of the following pieces of information.

An indication for deactivating and/or discontinuing data collection may include an indication (e.g., flag or bit) that data collection prioritization is deactivated or discontinued. An indication for deactivating and/or discontinuing data collection prioritization may include an identification of one or more data collection/measurement configuration(s) to be no longer prioritized. An indication for deactivating and/or discontinuing data collection prioritization may include an identification or one or more data, measurements, and/or event(s) within a data collection configuration to be no longer prioritized. An indication for deactivating and/or discontinuing data collection prioritization may include an indication of whether to release the data collection configuration(s) associated with the deactivated prioritization. An indication for deactivating and/or discontinuing data collection may include an indication of whether to delete collected data associated with the deactivated prioritization.

Upon reception of the discontinuation of data collection prioritization, the WTRU may (e.g., via additional indication or specification) perform one or more of the following actions. The WTRU may continue with the existing data collection prioritization. The WTRU may terminate data collection prioritization. The WTRU may release any existing data collection prioritization. The WTRU may clear collected data associated with prioritization (e.g., the entire data collection buffer or only data associated with the prioritization request).

Whether the WTRU performs the above actions to all data collection configuration(s) and/or a specific type of data and/or data collection configuration(s) may depend on whether the network indication explicitly refers to all configuration(s)/data and/or a specific prioritization.

A WTRU may perform methods for data collection prioritization. In examples, data collected by a WTRU (e.g., and/or network) may be assigned and/or configured with a specific priority. Prioritized data may be classified into one or more (e.g., two) distinct categories. For example, data may be prioritized as either “high priority” (e.g., “first priority”) data, or “low priority” (e.g., “second priority”) data. In examples, the data may be assigned multiple (e.g., more than two categories), wherein the WTRU will be provided/configured and/or specified with a relative ranking system to determine the relative priority of different classifications of data (e.g., based on a numerical priority value.

The WTRU may receive within a data collection configuration a priority in which to perform the measurements. In one example, the WTRU may receive multiple (e.g., two or more) data collection configurations, each with an assigned priority. In examples, the WTRU may prioritize specific event(s) and/or measurements within a data collection configuration. Examples of specific measurements and/or event(s) in which may be prioritized include, but are not limited to: measurements that are above a specific threshold (e.g., L1/L3 RSRP, SINR, RSRQ); measurements that are below a specific threshold (e.g., L1/L3 RSRP, SINR, RSRQ); the fulfillment of one or more measurement events (e.g., A1/A2/A3/A4/A5, B1/B2 etc.); detecting a positioning reference signal (PRS); detecting beam failure; detecting radio link failure; detecting that the WTRU is out of sync; detecting that the is in sync.

In some embodiments, the WTRU may prioritize data collection configuration(s) and/or data/events within a data collection configuration to support a particular model training (e.g., to ensure that model training can be done as quickly as possible). In examples, a WTRU may prioritize data/events that are associated with a particular use case (e.g., beam management, positioning etc.); data which is used for real-time and/or online training; and/or data which is used to train a model.

How the WTRU prioritizes collected data may be pre-configured and/or indicated to the WTRU (e.g., semi statically). In other embodiments, how the WTRU prioritizes data may be indicated dynamically (e.g., via a data collection prioritization activation message).

The WTRU may be triggered to initiate prioritization of collected data. In some embodiments, the WTRU may (e.g., always) apply the same prioritization of data (e.g., if configured). In other embodiments, the WTRU may prioritize data occasionally. For example, the WTRU may prioritize data if (e.g., only if) activated by the network. In examples, the WTRU may prioritize specific data collection configuration(s) and/or types of data/event(s) within (e.g., only within) a data collection configuration.

In one embodiment, the WTRU may only apply data prioritization based on fulfillment of one or more criteria. Examples of criteria that may trigger the WTRU to prioritize collected data include but are not limited to: the WTRU data collection buffer being full; the WTRU data collection buffer being about to become full (e.g., the buffer is within X% of being full, or within Y amount of data); the WTRU data collection buffer having a specific amount of one priority of data; a particular model needing to be trained; the WTRU receiving a request from an external source (e.g., an over the top (OTT) server); the network activating and/or updating a data collection prioritization; and/or the WTRU receiving a data collection configuration.

In examples, the satisfaction of one or more of the above triggers may be used to trigger a WTRU request for data prioritization. Upon fulfillment of a trigger to prioritize data, the WTRU may autonomously apply data collection prioritization, or the WTRU may first notify the network (e.g., and possible receive a configuration) prior to applying data collection prioritization.

A WTRU may perform prioritization of already logged/collected data upon prioritization of data. In examples, the activation and/or prioritization of data may impact how the already logged/collected data is treated. In examples, if the WTRU has already collected data without prioritization, the WTRU may not adjust the data already collected within the data collection buffer and continue with prioritization of new data. In examples, the WTRU may prioritize relevant data already logged/collected within the data collection buffer.

In examples, upon re-prioritization of a data collection configuration, the WTRU may maintain the priority of the already logged data according to the previous prioritization level. The WTRU may store newly collected data according to the updated prioritization. In examples, the WTRU may re-prioritize the data already stored within the data collection buffer according to the new prioritization level.

In examples, upon discontinuing data collection the WTRU may also delete the prioritization of some, or all of the data already collected (e.g., the data within the data collection buffer may no longer be treated as data having different priorities). In examples, the WTRU may maintain the priorities of the already collected data within the data collection buffer upon deactivation of data collection prioritization. However any newly logged/collected data may not follow the same prioritization.

In examples, upon prioritization, re-prioritization, and/or de-prioritization of data collection, the WTRU may flush the data collection buffer. Whether the WTRU flushes the buffer may be based on a network indication or configuration. In examples, the WTRU may (e.g., only) flush data associated with the data and/or data collection configuration associated with the change in prioritization status.

In examples, prioritization, reprioritization, and/or de-prioritization of data may trigger the reporting of collected data. In some embodiments, the WTRU may only apply the updated prioritization (e.g., upon reporting and/or clearing of the collected data).

A WTRU may support management of collected data with different priorities. In examples, when the data collection buffer becomes full the WTRU may terminate the logging and/or collection of data. When the data collection buffer becomes the full the WTRU may report the collected data (e.g., as described herein) and/or trigger a data collection BSR (e.g., as described herein). The WTRU may manage the contents of the data collection buffer by removing selected data from the data collection buffer (e.g., to continue data collection of high priority data at the expense of lower priority data). When and how this data is removed may be subject to specific configuration and/or the satisfaction of associated criteria.

A WTRU may be triggered to delete contents of collected data. In examples, the WTRU may remove data from a data collection buffer (e.g., prior to reporting such data). For example, the WTRU may remove data assigned/configured as “low priority” to free up space for data which is classified as “high priority.”

The removal of the data may be based on network indication. A network indication to remove data from a data collection buffer may include, for example, one or more of the following indications and/or pieces of information: an indication to remove data associated with a particular data collection configuration; an indication to remove data associated with a particular priority level; an indication to remove data below a particular priority level; an indication to remove data associated with a particular measurement/event type; and/or a particular amount of data to remove (e.g., number of bytes, % of data collection buffer etc.).

The WTRU may request data removal from the network (e.g., to support identification of which data should be removed by the network). The request may include additional assistance information to support identification and removal of data from the data collection buffer. The request may comprise, for example, a data collection buffer status report (e.g., as described herein). The WTRU assistance information for data removal may include, but is not limited to, one or more of the following indications and/or pieces of information: an indication (e.g., a flag and/or bit) requesting the data to be removed; the preferred data to be removed by the network (e.g., data associated with a particular data collection configuration, priority level, below a particular priority level and/or associated with a particular measurement/event type); the amount of data the WTRU would like to remove; the amount of data associated with a particular priority type; which data the WTRU cannot remove or needs to maintain; the WTRU data collection buffer is full; the WTRU data collection buffer is about to become full (e.g., the buffer is within X % of being full, or within Y amount of data).

In examples, the removal of collected data may be based on satisfaction of one or more criteria. Criteria to remove data may be configured for some or all data collection configuration(s). One or more (e.g., all) data collection configurations may use common criteria, or each data collection configuration may be configured with a different criterion to remove data from the data collection buffer. In examples, the WTRU may remove data associated with a specific data collection configuration based on, for example, satisfaction one or more of the following criteria: The buffer status becoming full; the data collection buffer status reaching a particular level (e.g., 80%, 90% etc.); and/or a model requiring the data becoming trained.

The WTRU may use one or more of the above requests to trigger a data removal request from the network, trigger reporting of collected data, and/or report a data collection buffer status report.

A WTRU may be configured with methods to delete collected data. In some embodiments, the WTRU may determine which data to remove/delete from a data collection buffer based on an explicit network indication. In examples, the WTRU may determine which data to remove from the data collection buffer based on a configuration (e.g., within the data collection configuration) which allows data to be removed from the data collection buffer and/or a configuration (e.g., within the data collection configuration) which forbids data to be deleted from the data collection buffer. In examples, the WTRU may determine which data to remove from the data collection buffer upon network request or indication, and/or upon satisfaction of an associated criteria for data removal.

In examples, the WTRU may continue to delete data from the data collection buffer until there is no more data remaining. In examples, the WTRU may (e.g., only) remove a specific amount of collected data. In another embodiment, the WTRU may remove (e.g., only) specific measurements and/or event(s) associated with a data collection configuration.

A WTRU may support reporting collected data with different priorities. A WTRU may identify and/or transmit data classified as “higher priority” when configured to collect data with different priorities. Ensuring that first or high priority data is prioritized for transmission, as well as ensuring that adequate resources are provided for its transmission, may help to ensure that data most critical for the operation and training of AIML models is logged and available when needed.

Embodiments described herein support the reporting of the collected data with different priorities, including the definition, contents, and triggering transmission of a new data collection buffer status report (BSR). The embodiments described herein may support allocation of reporting resources, as well as the triggering criteria and transmission of collected data with different priorities.

A WTRU may be configured with a data collection buffer status report (BSR). In examples, the WTRU may inform the network (e.g., upon network request or being triggered based on some criteria) of the status of the data collection buffer. The WTRU may send information relating to the data collection buffer, including, for example, the amount of data in the buffer associated with each different priority. This information may help the network allocate the correct amount of reporting resources to transmit the collected data (e.g., especially for data which is categorized as high priority).

The WTRU may provide the information relating to the data collection buffer in a data collection BSR, the contents of which are now considered. In some embodiments, the WTRU may report the buffer status (e.g., specifically related to data collection) via a dedicated buffer status report, herein referred to as a data collection buffer status report (BSR). A data collection BSR may be used, for example, to support network-controlled buffer management (e.g., where the network controls which and how much data to remove from the data collection buffer) and/or the allocation of resources for data collection reporting.

The data collection BSR may indicate the amount of data and/or space contained within the data collection buffer. In examples, the data collection BSR may include additional information regarding the collected data, for example, one or more of the following pieces of information.

The data collection BSR may include the total size of the data collection buffer. The data collection BSR may include the currently used and/or remaining amount of buffer memory allocated for data collection. The data collection BSR may include the currently used and/or remaining amount of buffer memory allocated for a specific data collection configuration. The data collection BSR may include the currently used and/or remaining amount of buffer memory allocated to a specific data event/measurement type. The data collection BSR may include the currently used and/or remaining amount of buffer memory allocated to a specific priority. The data collection BSR may include the currently used and/or remaining amount of buffer memory allocated to priorities above/below a threshold.

Depending on the information contained within the data collection BSR, two or more different BSRs may be defined. For example, a basic data collection BSR (e.g., indicating the remaining space of the data collection buffer and/or the amount of information within the data collection BSR) may be defined, and one or more detailed data collection BSRs (e.g., indicating additional assistance information related to the detailed types of data within the data collection BSR such as that listed about) may be defined.

A WTRU may be triggered to report a data collection BSR. In examples, the WTRU may trigger transmission of a data collection BSR. In examples, transmission of the data collection BSR may be based on a network request. The network request may further indicate whether the WTRU should transmit the basic or a detailed BSR, and/or provide resources for the transmission of the BSR.

In examples, the WTRU may trigger transmission of a data collection BSR upon satisfaction of one or more conditions and/or criteria. Transmission of a data collection BSR may be triggered, for example, by one or more of the following conditions and/or criteria.

A WTRU may be triggered to send a data collection BSR periodically (e.g., based on a configuration). A WTRU may be triggered to send a data collection BSR upon receiving a network request. A WTRU may be triggered to send a data collection BSR when the data collection buffer has become full. A WTRU may be triggered to send a data collection BSR when the data collection buffer is about to become full (e.g., x% full). A WTRU may be triggered to send a data collection BSR upon reaching a specific level (e.g., amount) of data for a given priority. A WTRU may be triggered to send a data collection BSR upon reaching a specific level (e.g., amount) of data for a given data collection configuration. A WTRU may be triggered to send a data collection BSR upon reaching a ratio of first and second priority data (e.g., 70% first priority 30% second priority). A WTRU may be triggered to send a data collection BSR if the WTRU has deleted/removed a specific amount of data from the data collection buffer. A WTRU may be triggered to send a data collection BSR if the WTRU cannot remove any more data from the data collection buffer.

The WTRU may transmit the data collection BSR via signaling. In examples, the WTRU may transmit the data collection BSR in a new MAC CE. In other examples, the WTRU may transmit such information, for example, as part of RRC signaling, UCI, NAS, RACH (e.g., MSG1/3/5 or MSGA) and/or PUSCH/PUCCH. The WTRU may have a dedicated SR configuration in order to request resources to transmit the data collection BSR.

In some embodiments (e.g., upon triggering transmission of a data collection BSR) the WTRU may determine whether to transmit a basic data collection BSR and/or a detailed data collection BSR. In examples, which BSR the WTRU transmits be based upon a network request; the condition which triggered transmission of the BSR; and/or the cause of the BSR (e.g., to report data, to update configuration(s), etc.)

A WTRU may support reporting collected data with different priorities. In examples, the WTRU may report collected data containing different categories of priority. High or “first” priority data may be transmitted prior to lower or “second” priority data. How the WTRU selects which data to transmit, as well as criteria to initiate transmission of such data is discussed herein.

A WTRU may evaluate conditions or criteria and determine to initiate data collection reporting procedure. In examples, the WTRU may initiate reporting of the collected data upon network request/indication. For example, the WTRU may trigger transmission of a data collection BSR. Upon reception of the data collection BSR, the network may determine the number of resources for data collection reporting. The NW may notify the WTRU to report the collected data via the indicated resources.

In examples, the WTRU may be configured to periodically report the collected data. The WTRU may have pre-configured resources (e.g., configured grants) in which to transmit the collected data. In case the WTRU has not collected any or sufficient data to transmit the collected data, the WTRU may simply skip the transmission occasion. If the WTRU has a filled (e.g., or almost filled, such as x% full) data collection buffer prior to a transmission opportunity, the WTRU may stop logging data (e.g., until the next transmission opportunity) and/or request additional transmission resources from the network.

The WTRU may trigger reporting of the collected data upon satisfaction of one or more conditions and/or criteria. In examples, the WTRU may trigger reporting of the collected data upon satisfaction of one or more conditions/criteria, including, but not limited to one or more of the following conditions/criteria.

The WTRU may trigger reporting of the collected data upon fulfillment of one or more criteria associated with transmission of the data collection BSR as described herein. The WTRU may trigger reporting of the collected data when the data collection buffer has become full. The WTRU may trigger reporting of the collected data when the data collection buffer is about to become full (e.g., 80% full). The WTRU may trigger reporting of the collected data upon reaching a ratio of first and second priority data (e.g., 70% first priority 30% second priority). The WTRU may trigger reporting of the collected data upon reaching a threshold number of data entries. The WTRU may trigger reporting of the collected data when a certain type of data meets a criterion (e.g., a record of RSRP is above a threshold RSRP value).

The WTRU may trigger reporting of the collected data based on a time or location based criteria. For example, the WTRU may be configured with time or location based conditions. In the case of using a non-terrestrial network (NTN), examples of conditions/events to trigger reporting may be: if/when the WTRU location is within a threshold distance from a reference location; and/or when the absolute time measured at the WTRU is within a time window (e.g., between a first time T1 and a second time T2).

In examples, a particular data collection configuration and/or data/event type may be associated with one or more of the above criteria. If an associated triggering criterion is satisfied, the WTRU may transmit only the data associated with the criteria which was satisfied. In another embodiment, the WTRU may transmit the entire set of collected data.

A WTRU may transmit collected data containing data of different priorities. In examples, the WTRU may transmit a data collection report including data of multiple priorities. The WTRU may transmit the data collection using resources already allocated and/or scheduled for WTRU transmission (e.g., via configured grant, and or dynamically scheduled resources. In examples, the WTRU may initiate RACH to acquire the necessary resources. The WTRU may use dedicated preambles, RNTIs, RACH resources and/or RACH occasions to indicate the cause of RACH is for data collection transmission. In another embodiment the WTRU may initiate a connection with a dedicated resume cause (e.g., data collection buffer filled) for data collection transmission to indicate that the WTRU wishes to transmit collected data.

In some embodiments the resources provided for transmission of the collected data may be insufficient to transmit some or all the data. In examples, the WTRU may prioritize the transmission of high priority data and/or a specific type of data. The WTRU may transmit a specific ratio of more than one type of data. Whether the WTRU may transmit only high priority data may be subject to configuration.

The WTRU may transmit the reported data via signaling. In examples, the WTRU may transmit the reported data via RRC signaling, MAC CE, NAS, UCI, RACH (e.g., MSG1/3/5 and/or MSGA) or PUSCH/PUCCH. In some embodiments, the WTRU may be forbidden from transmitting collected data of a specific type via a certain type of signaling and/or within a specific RRC state. In examples, the WTRU may transmit information sensitive to security and privacy (e.g., WTRU location information) only via specific signaling types (e.g., RRC signaling, or within RRC connected state). In examples, the WTRU may transmit, for example, L3 measurements via RACH or random access signaling.

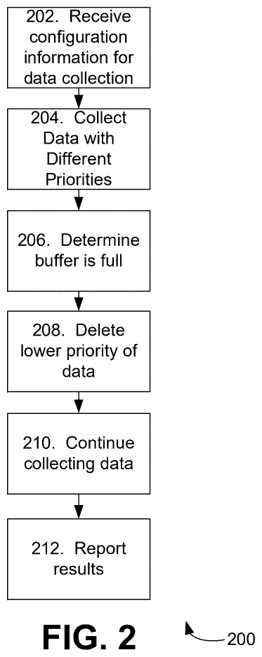

FIG. 2 is a flow chart showing an example of a procedure for a WTRU at 200. At 202, the WTRU may receive configuration information for data collection with data of multiple priorities. At 204, the WTRU may perform data collection in accordance with the configuration information. At 206, the WTRU may determine that a buffer where the WTRU is storing collected data is full. At 208, the WTRU may determine to delete lower priority data in the buffer, to make room for more data of a higher priority. At 210, the WTRU may continue collecting data (e.g., data of a higher priority). At 212, the WTRU may send a report indicating results of the data collection (e.g., results for the higher priority data collection and the lower priority data collection).

1. A wireless transmit/receive unit comprising
a processor configured to:
receive a message comprising configuration information for a first data collection and configuration information for a second data collection, wherein the first data collection is associated with a first priority and the second data collection is associated with a second priority, wherein the first priority is higher than the second priority;
make measurements of reference signal received power (RSRP), signal to interference plus noise (SINR), or reference signal received quality (RSRQ) in accordance with the configuration information for the first data collection and the configuration information for the second data collection;
store data comprising the measurements in a buffer;
determine that the buffer is full;
determine, for buffer management, to delete a subset of the data associated with the second data collection and continue collecting data associated with the first data collection; and
send a report indicating a first result of the first data collection and a second result of the second data collection.

2. The WTRU of claim 1, wherein the processor is configured to delete the subset of data associated with the second data collection based on the buffer being full and based on the priority of the first data collection being higher than the priority of the second data collection.

3. The WTRU of claim 1, wherein the processor is configured to make RSRP, SINR, or RSRQ measurements of a positioning reference signal (PRS).

4. The WTRU of claim 1, wherein the processor is configured to determine that the buffer is full by comparing a percentage that the buffer is full with a threshold.

5. The WTRU of claim 1, wherein the processor is configured to delete all of the data associated with the second collection from the buffer upon determining that the buffer is full.

6. The WTRU of claim 1, wherein the first priority is indicated by a first numerical value, and the second priority is indicated by a second numerical value, wherein the first numerical value is different than the second numerical value.

7. The WTRU of claim 1, wherein the processor is configured to:
send a request for transmission resources, based on the determination that the buffer is full.

8. The WTRU of claim 1, wherein the processor is configured to:
send a data collection buffer status report (BSR) based on the determination that the buffer is full or in response to a network request.

9. The WTRU of claim 1, wherein the processor is configured to:
send an indication of a capability of the WTRU for handling data collection with data of different priorities.

10. The WTRU of claim 1, wherein the configuration information further comprises an indication of resources for reporting associated with the first data collection or the second data collection.

11. A method for a wireless transmit/receive unit, the method comprising:
receiving a message comprising configuration information for a first data collection and configuration information for a second data collection, wherein the first data collection is associated with a first priority and the second data collection is associated with a second priority, wherein the first priority is higher than the second priority;
performing the first data collection and the second data collection, wherein performing the first data collection and the second data collection comprises making measurements of reference signal received power (RSRP), signal to interference plus noise (SINR), or reference signal received quality (RSRQ) and storing data comprising the measurements in a buffer;
determining that the buffer is full;
performing buffer management, wherein performing buffer management comprises deleting a subset of the data associated with the second data collection and continuing collecting data associated with the first data collection;
sending a report indicating a first result of the first data collection and a second result of the second data collection.

12. The method of claim 11, further comprising deleting the subset of data associated with the second data collection based on the buffer being full and based on the priority of the first data collection being higher than the priority of the second data collection.

13. The method of claim 11, further comprising making RSRP, SINR, or RSRQ measurements of a positioning reference signal (PRS).

14. The method of claim 11, further comprising determining that the buffer is full by comparing a percentage that the buffer is full with a threshold.

15. The method of claim 11, further comprising deleting all of the data associated with the second collection from the buffer upon determining that the buffer is full.

16. The method of claim 11, wherein the first priority is indicated by a first numerical value, and the second priority is indicated by a second numerical value, wherein the first numerical value is different than the second numerical value.

17. The method of claim 11, further comprising:
sending a request for transmission resources, based on determining that the buffer is full.

18. The method of claim 11, further comprising:
sending a data collection buffer status report (BSR) based on determining that the buffer is full or in response to a network request.

19. The method of claim 11, further comprising:
sending an indication of a capability of the WTRU for handling data collection with data of different priorities.

20. The method of claim 11, wherein the configuration information further comprises an indication of resources for reporting associated with the first data collection or the second data collection.
